(19) United States
(12) Patent Application Publication
(10) Pub. No.: US 2025/0104159 A1
(43) Pub. Date: Mar. 27, 2025

(54) System and Methods for calculating common financial valuation measure with negative Divisors (Earnings, Cash Flow, Book Value, EBITDA, EBT and etc.)

(71) Applicant: Ferris Ahn, McLean, VA (US)

(72) Inventor: Ferris Ahn, McLean, VA (US)

(21) Appl. No.: 18/471,401

(22) Filed: Sep. 21, 2023

(51) Int. Cl. G06Q 40/12

(52) U.S. Cl. CPC G06Q 40/12

(57) ABSTRACT

System and Methods for calculating common financial valuation measure with negative Divisors (Earnings, Cash Flow, Book Value, EBITDA, EBT and etc).

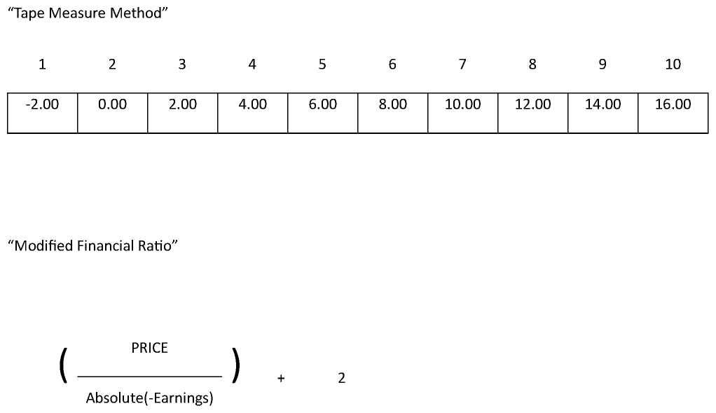

To the best of my knowledge, there has been no prior attempt to illustrate the P/E (Price-to-Earnings) multiple when a company has negative earnings. Typically, the P/E multiple is left blank or marked as “N/A” in such cases. While this approach may seem mathematically sound, considering it from a three-dimensional perspective can offer a solution.

Imagine taking a tape measure and marking the left end with −2 and the right end with 16. Now, begin folding the tape from the right end, incrementally in units of 2. After ten folds, you'll arrive at a solution for visualizing the P/E multiple even when earnings are negative. You will end up folding 10 times.

| 1 | 2 | 3 | 4 | 5 | 6 | 7 | 8 | 9 | 10 |
|---|---|---|---|---|---|---|---|---|---|
| −2.00 | 0.00 | 2.00 | 4.00 | 6.00 | 8.00 | 10.00 | 12.00 | 14.00 | 16.00 |

Based on this, we can arrive at the following equation:

$$( \frac{PRICE}{Absolute ( - Earnings )} ) + 2$$

Using this equation, we can extend its application beyond Price multiples to encompass negative Cash Flow, Earnings, Book Value, and any financial ratios that are represented as multiples.

1. Receiving Financial Data:
a. Receiving financial data for a company, including Price (P) and Earnings (E), where E may be negative, or other financial metrics such as Cash Flow and Book Value;

2. Visualizing the Modified Financial Ratio (“Tape Measure Method”):
a. Representing the modified financial ratio graphically on a three-dimensional scale, utilizing a left endpoint marked and a right endpoint;
b. Folding the scale from the right endpoint incrementally, until a solution is reached for visualizing the modified financial ratio for companies with negative earnings;

3. Determining the Modified Financial Ratio:
A. Calculating a modified financial ratio for companies with negative earnings by utilizing the formula:
$$Modified Ratio = ( \frac{P}{Absolute ( - E )} ) + 2$$
where P is the Price and E is the Earnings;
a. Determining the absolute value of Earnings (|E|);
b. Dividing P by |−E|, P/|−E|;
c. Adding 2 to the result.
B. Extending the application of the modified financial ratio to other financial metrics, such as negative Cash Flow, negative Book Value, and other financial ratios represented as multiples.

4. Application in Financial Markets and Security Analysis:
a. Utilizing the modified financial ratio for security analysis and financial market evaluation;
b. Incorporating the modified financial ratio in financial periodicals, financial data feeds, and on websites dedicated to financial analysis.
c. Presenting the modified financial ratio as a visual representation to enhance the understanding of financial performance metrics for companies with negative earnings or other negative financial indicators.
This claim covers the method for calculating and visualizing financial ratios for companies with negative earnings and extends the application to various negative financial metrics, including its implementation on computer systems and presentation in financial media and data feeds.
